(19) United States
(12) Patent Application Publication
(10) Pub. No.: US 2025/0385749 A1
(43) Pub. Date: Dec. 18, 2025

(54) NEW MODULATION AND CODING SCHEMES FOR NEXT-GENERATION WLAN

(71) Applicant: MEDIATEK INC., Hsinchu City (TW)

(72) Inventors: Shengquan HU, San Jose, CA (US); Jianhan LIU, San Jose, CA (US); Thomas Edward PARE, Jr., San Jose, CA (US)

(21) Appl. No.: 18/879,069

(22) PCT Filed: Sep. 21, 2023
(86) PCT No.: PCT/CN2023/120474

§ 371 Date: Dec. 26, 2024

Related U.S. Application Data
(60) Provisional application No. 63/376,629, filed on Sep. 22, 2022.

(51) Int. Cl. H04L 1/00; H04B 17/309

(52) U.S. Cl. CPC H04L 1/0003; H04B 17/346; H04L 1/0009

(57) ABSTRACT

Techniques pertaining to new modulation and coding scheme (MCS) levels for next-generation wireless local area networks (WLANs) are described. An apparatus generates a signal using an MCS level not defined in an Institute of Electrical and Electronics Engineers (IEEE) 802.11be specification. The apparatus then performs a wireless communication using the signal. Each of a sensitivity signal-to-noise ratio (SNR) gap and a spectral efficiency gap between two adjacent MCS levels from a combination of the plurality of MCS levels and a plurality of existing MCS levels defined in the IEEE 802.11be specification is less than that between two adjacent MCS levels from the plurality of existing MCS levels.

### CROSS REFERENCE TO RELATED PATENT APPLICATION

The present disclosure is part of a non-provisional patent application claiming the priority benefit of U.S. Provisional Patent Application No. 63/376,629, filed 22 Sep. 2022, the content of which herein being incorporated by reference in its entirety.

### TECHNICAL FIELD

The present disclosure is generally related to wireless communications and, more particularly, to new modulation and coding scheme (MCS) levels for next-generation wireless local area networks (WLANs).

### BACKGROUND

Unless otherwise indicated herein, approaches described in this section are not prior art to the claims listed below and are not admitted as prior art by inclusion in this section.

In wireless communications, such as in accordance with the Institute of Electrical and Electronics Engineers (IEEE) 802.11 standards, high reliability and higher throughput at different signal-to-noise ratio (SNR) levels are the main targets for next-generation wireless connectivity. In IEEE 802.11be, there are total sixteen MCS levels, from the lowest data rate of MCS15 (using binary phase-shift keying (BPSK) plus dual-carrier modulation (DCM) with a coding rate (R) of ½) to the highest data rate of MCS13 (using 4096 quadrature amplitude modulation (QAM) with R=⅚). In addition, MCS14 is defined in IEEE 802.11be for 6 GHz band for single-user (SU) only with duplication (DUP) on 80 MHz, 160 MHz and 320 MHz, which uses BPSK+DCM+DUP with R=½. However, the gap of sensitivity SNR requirements between some adjacent MCS levels is quite large and is greater than 3 dB. It would be beneficial to fill both the sensitivity SNR gaps and spectral efficiency gaps with new MCS levels. Therefore, there is a need for a solution of new MCS levels for next-generation WLANs.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to new MCS levels for next-generation WLANs. It is believed that, under various proposed schemes in accordance with the present disclosure, definition of finer MCS levels may improve link adaptation performance. Moreover, the new MCS levels under the various proposed schemes may be based on existing modulations (e.g., from BPSK to 4096QAM). The coding rate may be based on either existing rates such as R=½, ⅔, ¾ and ⅚ or low and high coding rates such as R=⅓, ¼, ⅙, ⅛, 1/12, ⅞ and 11/12, for example.

In one aspect, a method may involve generating a signal using an MCS level not defined in an IEEE 802.11be specification. The method may also involve performing a wireless communication using the signal. Each of a sensitivity SNR gap and a spectral efficiency gap between two adjacent MCS levels from a combination of the plurality of MCS levels and a plurality of existing MCS levels defined in the IEEE 802.11be specification may be less than that between two adjacent MCS levels from the plurality of existing MCS levels.

In another aspect, an apparatus may include a transceiver configured to communicate wirelessly and a processor coupled to the transceiver. The processor may generate a signal using an MCS level not defined in an IEEE 802.11be specification. The processor may also perform, via the transceiver, a wireless communication using the signal. Each of a sensitivity SNR gap and a spectral efficiency gap between two adjacent MCS levels from a combination of the plurality of MCS levels and a plurality of existing MCS levels defined in the IEEE 802.11be specification may be less than that between two adjacent MCS levels from the plurality of existing MCS levels.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example design under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example design under a proposed scheme in accordance with the present disclosure.

FIG. 9 is a diagram of an example scenario under a proposed scheme in accordance with the present disclosure.

FIG. 10 is a diagram of an example scenario under a proposed scheme in accordance with the present disclosure.

FIG. 11 is a block diagram of an example communication system in accordance with an implementation of the present disclosure.

FIG. 12 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

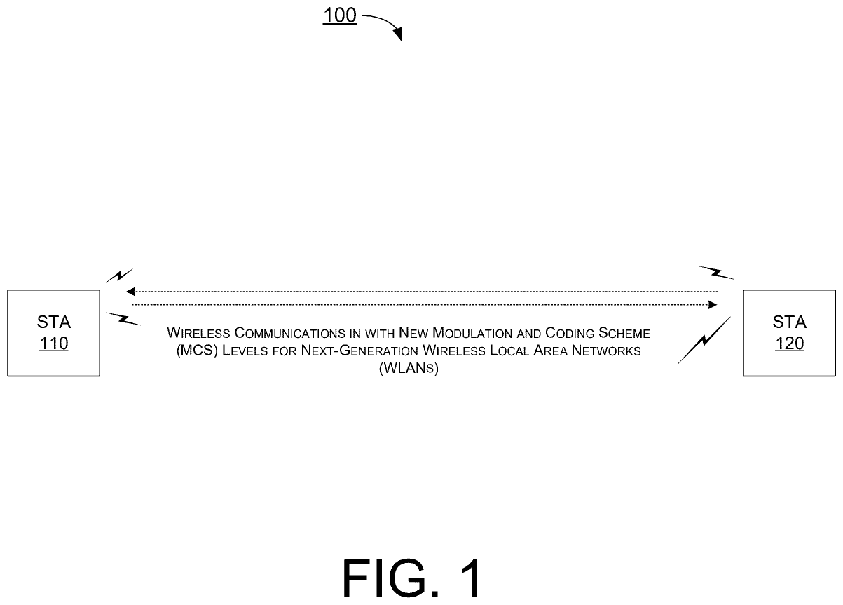

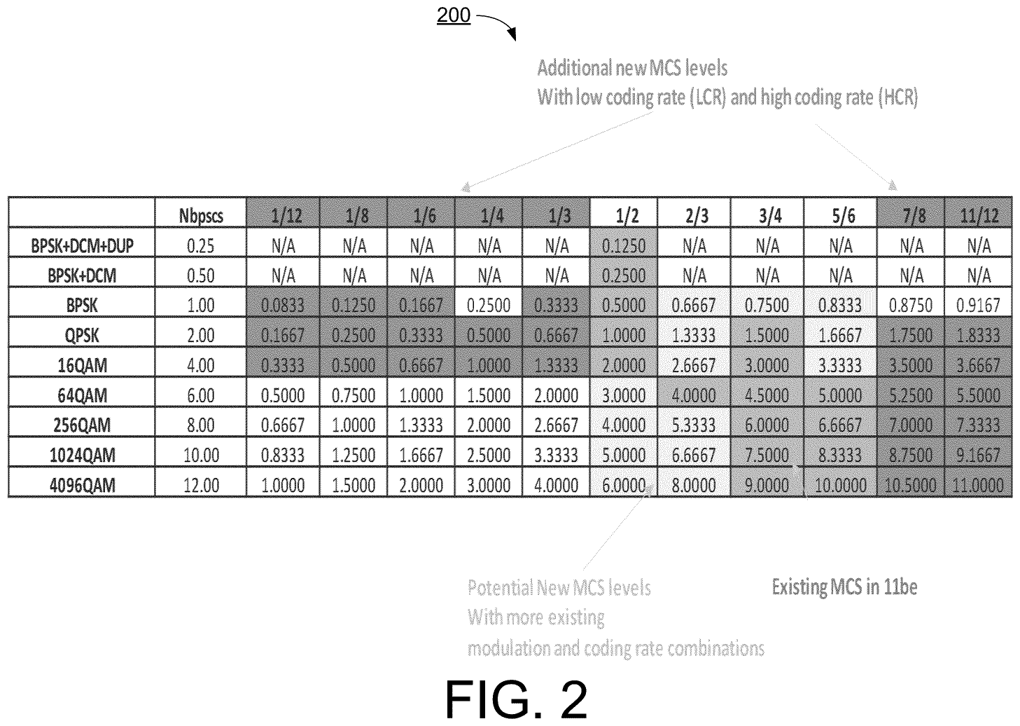

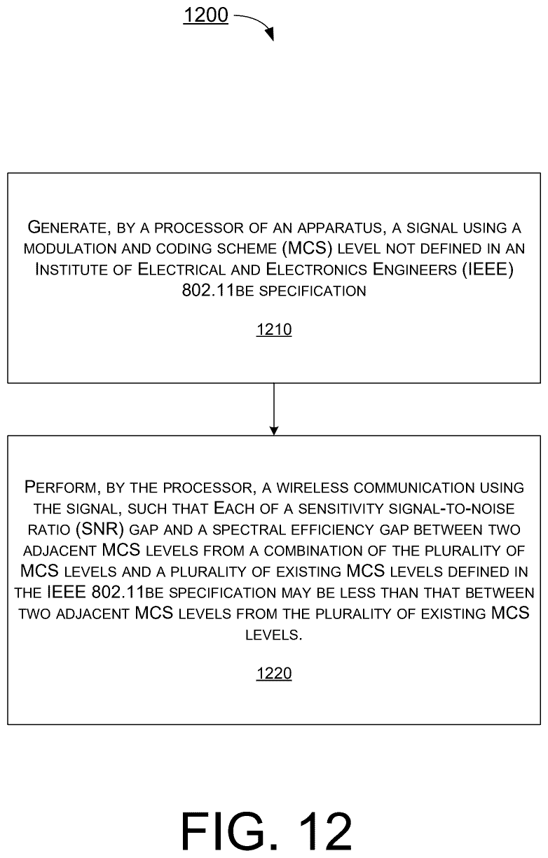

Implementations in accordance with the present disclosure relate to various techniques, methods, schemes and/or solutions pertaining to new MCS levels for next-generation WLANs. According to the present disclosure, a number of possible solutions may be implemented separately or jointly. That is, although these possible solutions may be described below separately, two or more of these possible solutions may be implemented in one combination or another. FIG. 1 illustrates an example network environment 100 in which various solutions and schemes in accordance with the present disclosure may be implemented. FIG. 2˜FIG. 12 illustrate examples of implementation of various proposed schemes in network environment 100 in accordance with the present disclosure. The following description of various proposed schemes is provided with reference to FIG. 1˜FIG. 12.

Referring to FIG. 1, network environment 100 may involve at least a station (STA) 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11be and future-developed standards such as IEEE802.11bn ultra-high reliability (UHR) system). Each of STA 110 and STA 120 may be configured to communicate with each other by utilizing the new MCS levels for next-generation WLANs in accordance with various proposed schemes described below. That is, either or both of STA 110 and STA 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

As defined in the IEEE 802.11be standard, there are a total of sixteen MCS levels. Each combination of modulation and coding rate has an associated spectral efficiency. When plotted on a graph, there is a significant spectral efficiency gap (up to 1 bit/tone) between certain pairs of two adjacent MCS levels. Moreover, when packet error rate (PER) versus sensitivity SNR for 20 MHz and for 80 MHz are plotted on a graph, there is a significant sensitivity SNR gap (e.g., 3˜4 dB) between certain pairs of two adjacent MCS levels. As such, it is believed that finer MCS levels (to be defined) may enable more accurate rate adaptation. Besides, next-generation Wi-Fi aims for throughput improvement at different SNR levels (e.g., low SNR for enhanced long-range applications and high SNR for short-distance and very-high-throughput applications).

In view of the above, under various proposed schemes in accordance with the present disclosure with respect to the design of new MCS levels, existing modulation and coding rate combinations may be utilized to fill up the sensitivity SNR gaps. Moreover, new MCS levels may be proposed to extend the SNR operation range. For instance, some new MCS levels may be proposed for low SNR operation for enhanced long-range applications, and other new MCS levels may be proposed for high SNR operation for high-throughput applications.

FIG. 2 illustrates an example design 200 under a proposed scheme in accordance with the present disclosure. The table of design 200 shows different combinations of modulation and coding rates for potential new MCS levels. Referring to FIG. 2, some of the combinations of modulation and coding rates (highlighted with a first type of shading) correspond to existing MCS levels as defined in IEEE 802.11be. Additionally, some of the combinations of modulation and coding rates (highlighted with a second type of shading) correspond to additional new MCS levels with low coding rate (LCR) and high coding rate (HCR). Moreover, some of the combinations of modulation and coding rates (highlighted with a third type of shading) correspond to potential new MCS levels with more existing modulation and coding rate combinations.

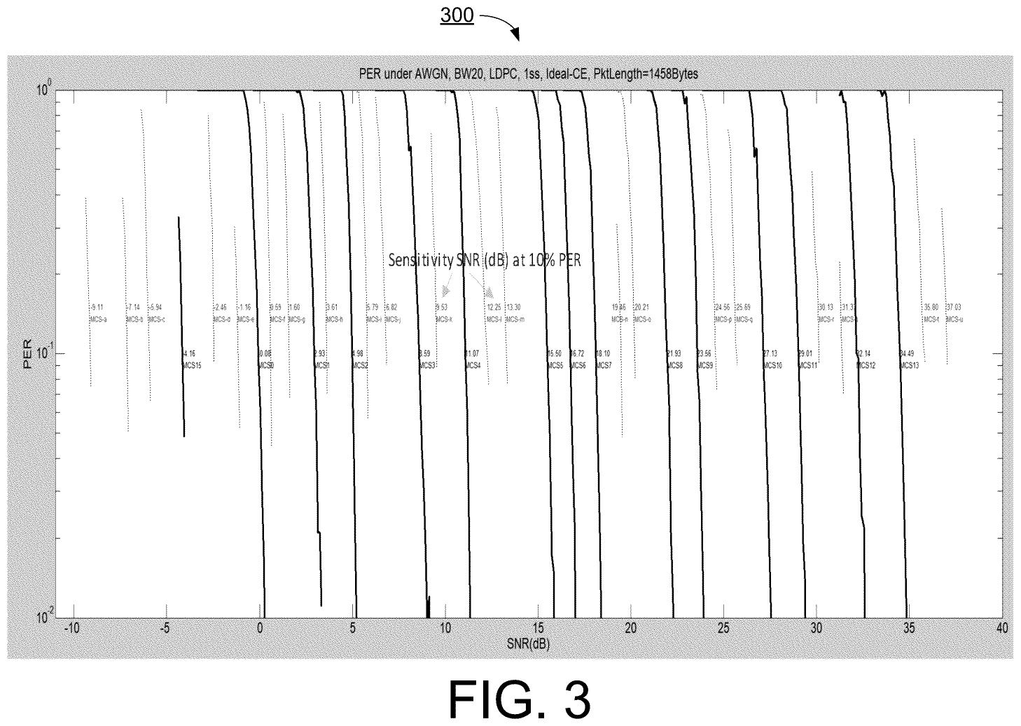

FIG. 3 illustrates an example scenario 300 under a proposed scheme in accordance with the present disclosure. In scenario 300, PER curves resulting from candidates of new MCS levels are plotted on a simulation graph along with PER curves resulting from existing MCS levels. The PER curves are simulated with a certain settings as follows: bandwidth=20 MHz; channel=additive white Gaussian noise (AWGN); coding=low-density parity-check (LDPC); channel estimation=ideal condition; packet length=1458 bytes; number of spatial stream (ss)=1 ss; and configuration=one transmitter antenna and one receiver antenna (1T1R). As shown in FIG. 3, by adding new MCS levels, the SNR gap between two adjacent MCS levels may be greatly reduced. The finer MCS levels may enable more accurate and smoother rate adaptation. In FIG. 3, the darker curves represent PER curves for existing MCS levels in IEEE 802.11be while the grey curves represent PER curves for potential new MCS levels.

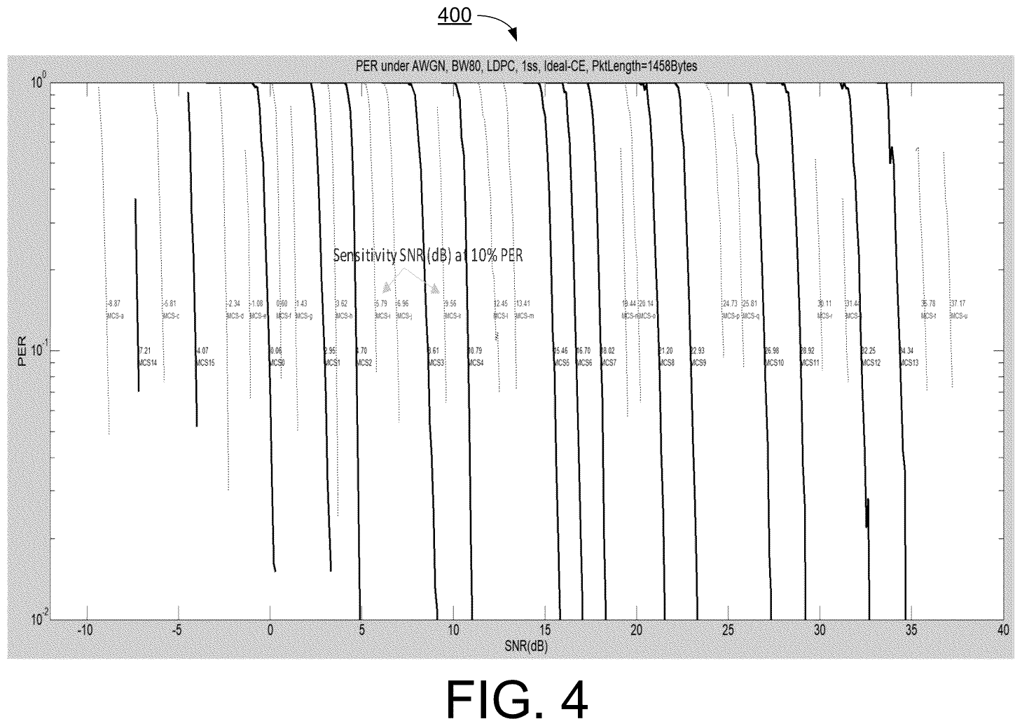

FIG. 4 illustrates an example scenario 400 under a proposed scheme in accordance with the present disclosure. In scenario 400, PER curves resulting from candidates of new MCS levels are plotted on a simulation graph along with PER curves resulting from existing MCS levels. The PER curves are simulated with a certain settings as follows: bandwidth=80 MHz; channel=15 AWGN; coding=LDPC; channel estimation=ideal condition; packet length=1458 bytes; number of spatial stream=1 ss; and configuration=1TIR. As shown in FIG. 4, by adding new MCS levels, the SNR gap between two adjacent MCS levels may be greatly reduced. The finer MCS levels may enable more accurate and smoother rate adaptation. In FIG. 4, the darker curves represent PER curves for existing MCS levels in IEEE 802.11be while the grey curves represent PER curves for potential new MCS levels.

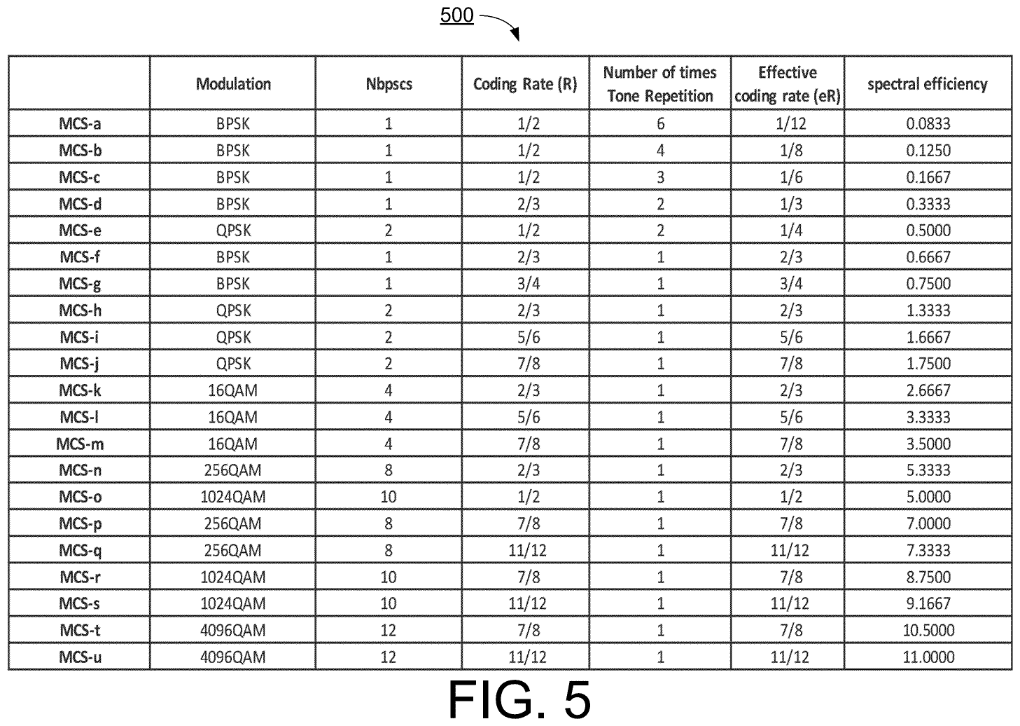

FIG. 5 illustrates an example design 500 under a proposed scheme in accordance with the present disclosure. The table of design 500 shows different modulation and coding rates for candidates of new MCS levels. Referring to FIG. 5, potential new MCS candidates, namely: MCS-a, MCS-b, MCS-c, MCS-d, MCS-e, MCS-f, MCS-g, MCS-h, MCS-i, MCS-j, MCS-k, MCS-l, MCS-m, MCS-n, MCS-o, MCS-p, MCS-q, MCS-r, MCS-s, MCS-t and MCS-u, may enable overall finer MCS definitions for better and smoother rate adaptation. It is noteworthy that MCS-i may also be with 64QAM, R=½.

Under a proposed scheme in accordance with the present disclosure, a subset of new MCS levels may be chosen from the candidates of new MCS levels shown in FIG. 5. For instance, the subset of selected new MCS levels may be chosen from the candidate set to fine-tune and/or optimize the MCS levels to balance performance and complexity. With the same spectral efficiency as MCS0, MCS-e (using quadrature phase-shift keying (QPSK) with an effective coding rate (eR) of ¼) in the table shown in FIG. 5 may achieve about 1 dB better performance. As such, MCS-e may be considered as an alternative MCS of MCS0. The following figures show example new finer MCS levels which may fill in the sensitivity SNR gaps.

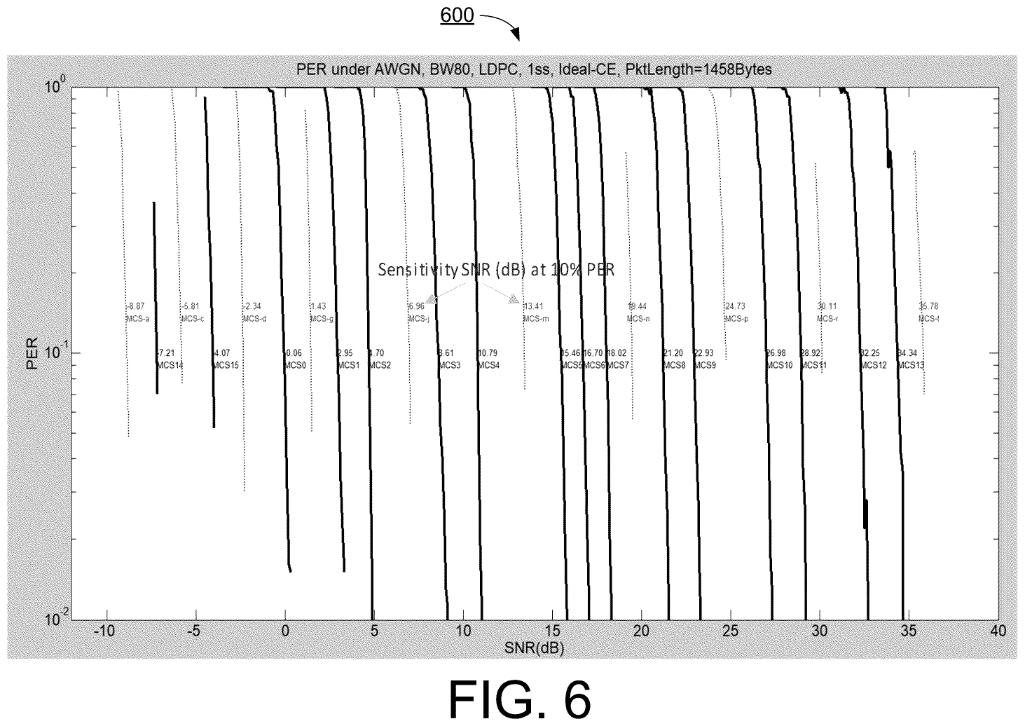

FIG. 6 illustrates an example scenario 600 under a proposed scheme in accordance with the present disclosure. Scenario 600 pertains to an example of new MCS for Wi-Fi 8 in 80 MHz. In scenario 600, PER curves resulting from candidates of new MCS levels are plotted on a simulation graph along with PER curves resulting from existing MCS levels. The PER curves are simulated with a certain settings as follows: bandwidth=80 MHz; channel=AWGN; coding=LDPC; channel estimation=ideal condition; packet length=1458 bytes; number of spatial stream=1 ss; and configuration=1TIR. In scenario 600, to balance the complexity and performance, a few MCS levels may be chosen from the new MCS candidate set as new MCS levels. As can be seen, although only a few new MCS levels are added, the SNR gap between two adjacent MCS levels may still be significantly reduced. In FIG. 6, the darker curves represent PER curves for existing MCS levels in IEEE 802.11be while the grey curves represent PER curves for potential new MCS levels.

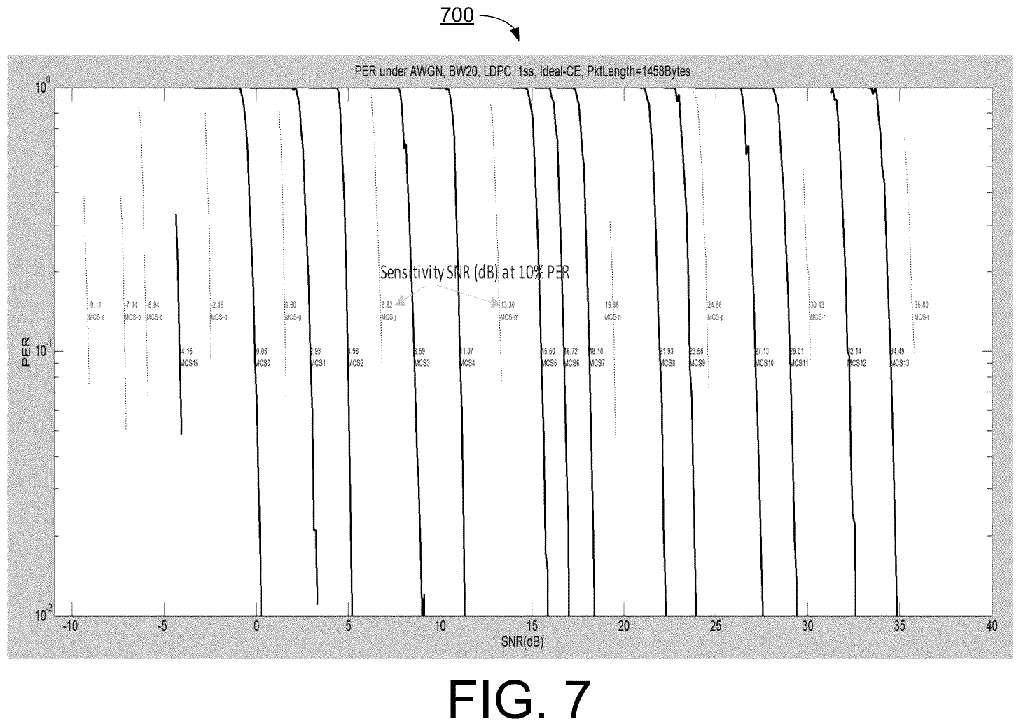

FIG. 7 illustrates an example scenario 700 under a proposed scheme in accordance with the present disclosure. Scenario 700 pertains to an example of new MCS for Wi-Fi 8 in 20 MHz. In scenario 700, PER curves resulting from candidates of new MCS levels are plotted on a simulation graph along with PER curves resulting from existing MCS levels. The PER curves are simulated with a certain settings as follows: bandwidth=20 MHz; channel=AWGN; coding=LDPC; channel estimation=ideal condition; packet length=1458 bytes; number of spatial stream=1ss; and configuration=1TIR. In scenario 600, to balance the complexity and performance, a few MCS levels may be chosen from the new MCS candidate set as new MCS levels. As can be seen, although only a few new MCS levels are added, the SNR gap between two adjacent MCS levels may still be significantly reduced. In FIG. 7, the darker curves represent PER curves for existing MCS levels in IEEE 802.11be while the grey curves represent PER curves for potential new MCS levels.

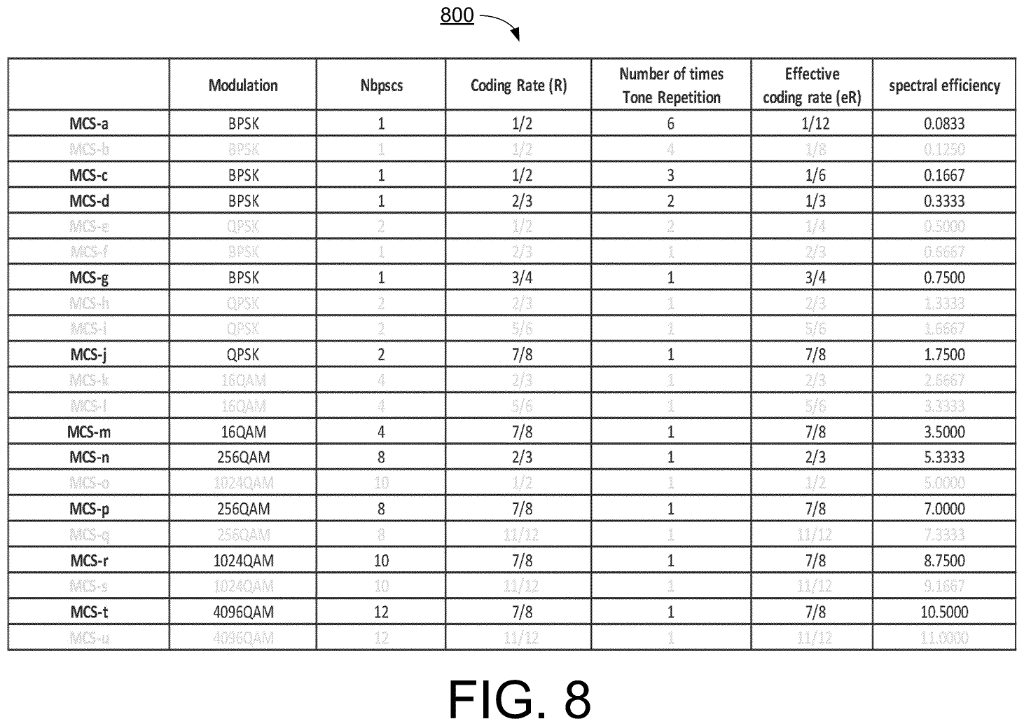

FIG. 8 illustrates an example design 800 under a proposed scheme in accordance with the present disclosure. The table of design 800 shows different modulation and coding rates for candidates of new MCS levels. Referring to FIG. 8, potential new MCS candidates for Wi-Fi 8 are highlighted with a darker font.

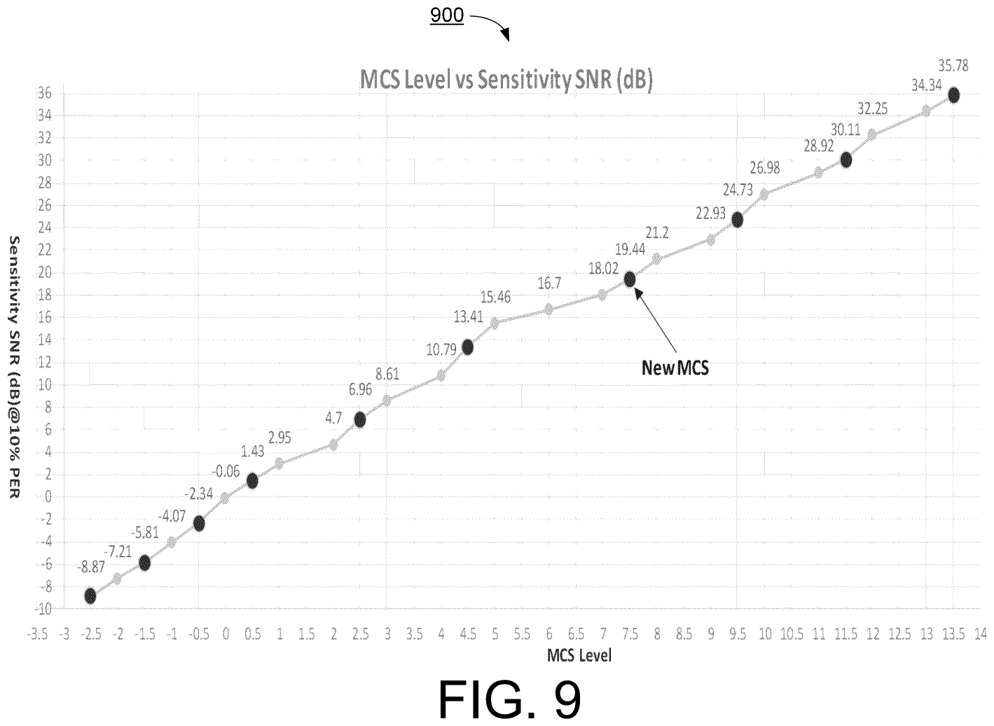

FIG. 9 illustrates an example scenario 900 under a proposed scheme in accordance with the present disclosure. Scenario 900 pertains to additional MCS levels versus sensitivity SNR. Referring to FIG. 9, the SNR gap between two adjacent MCS levels are reduced by adding some new MCS levels. It is noteworthy that, in FIG. 9, the x-axis respective value of proposed potential new MCS level versus sensitivity SNR is −2.5, −1.5, −0.5,2.5,4.5,7.5,9.5,11.5,13.5 for the new MCS levels MCS-a, c, d, g, j, m, n, p, r, t in the table shown in FIG. 5. Moreover, the respective value of existing MCS level in IEEE 802.11be versus sensitivity SNR is −2 for MCS-14, −1 for MCS-15, 0 for MCS-0, 1 for MCS-1, . . . , 13 for MCS-13.

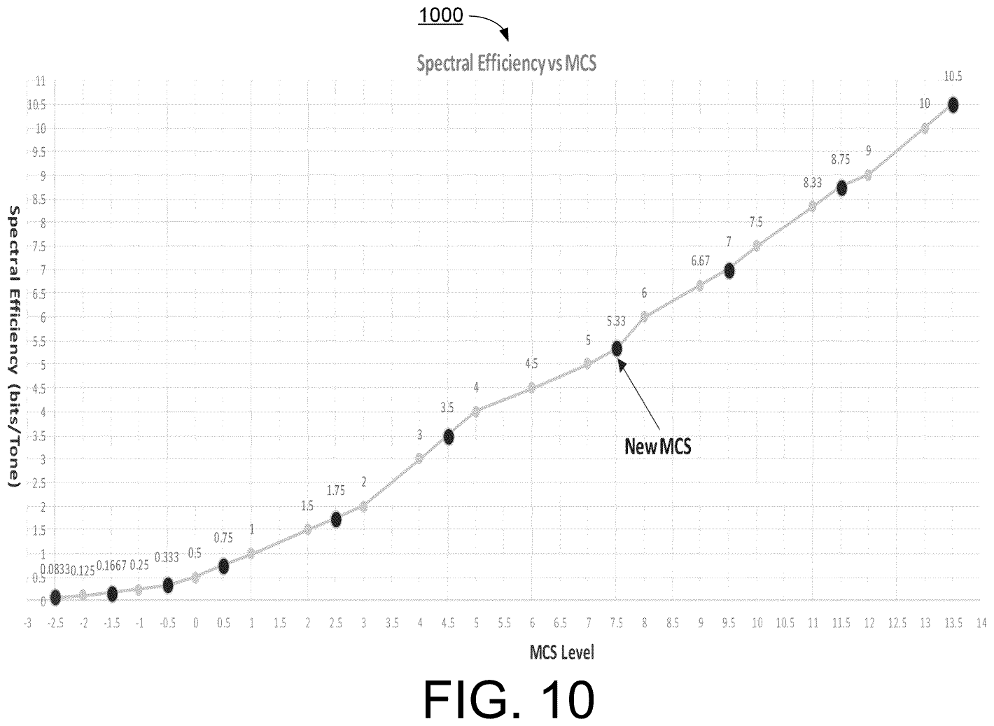

FIG. 10 illustrates an example scenario 1000 under a proposed scheme in accordance with the present disclosure. Scenario 1000 pertains to additional MCS levels versus spectral efficiency. Referring to FIG. 10, the spectral efficiency gap between two adjacent MCS levels are reduced by adding some new MCS levels. It is noteworthy that, in FIG. 10, the x-axis respective value of proposed potential MCS level versus spectral efficiency is −2.5, −1.5, −0.5,2.5,4.5,7.5,9.5,11.5,13.5 for the new MCS levels MCS-a, c, d, g, j, m, n, p, r, t in the table shown in FIG. 5. Moreover, the respective value of existing MCS level in IEEE 802.11be versus spectral efficiency is −2 for MCS-14,−1 for MCS-15, 0 for MCS-0, 1 for MCS-1, . . . , 13 for MCS-13.

### Illustrative Implementations

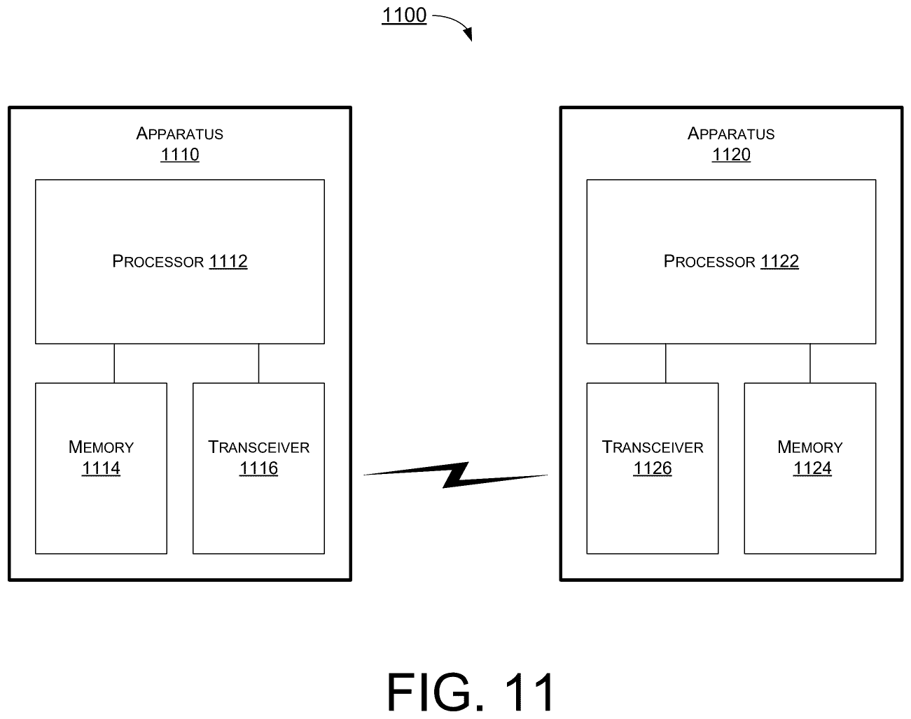

FIG. 11 illustrates an example system 1100 having at least an example apparatus 1110 and an example apparatus 1120 in accordance with an implementation of the present disclosure. Each of apparatus 1110 and apparatus 1120 may perform various functions to implement schemes, techniques, processes and methods described herein pertaining to new MCS levels for next-generation WLANs, including the various schemes described above with respect to various proposed designs, concepts, schemes, systems and methods described above as well as processes described below. For instance, apparatus 1110 may be implemented in STA 110 and apparatus 1120 may be implemented in STA 120, or vice versa.

Each of apparatus 1110 and apparatus 1120 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 1110 and apparatus 1120 may be implemented in a smartphone, a smart watch, a personal digital assistant, a digital camera, or a computing equipment such as a tablet computer, a laptop computer or a notebook computer. Each of apparatus 1110 and apparatus 1120 may also be a part of a machine type apparatus, which may be an IoT apparatus such as an immobile or a stationary apparatus, a home apparatus, a wire communication apparatus or a computing apparatus. For instance, each of apparatus 1110 and apparatus 1120 may be implemented in a smart thermostat, a smart fridge, a smart door lock, a wireless speaker or a home control center. When implemented in or as a network apparatus, apparatus 1110 and/or apparatus 1120 may be implemented in a network node, such as an AP in a WLAN.

In some implementations, each of apparatus 1110 and apparatus 1120 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1110 and apparatus 1120 may be implemented in or as a STA or an AP. Each of apparatus 1110 and apparatus 1120 may include at least some of those components shown in FIG. 11 such as a processor 1112 and a processor 1122, respectively, for example. Each of apparatus 1110 and apparatus 1120 may further include one or more other components not pertinent to the proposed scheme of the present disclosure (e.g., internal power supply, display device and/or user interface device), and, thus, such component(s) of apparatus 1110 and apparatus 1120 are neither shown in FIG. 11 nor described below in the interest of simplicity and brevity.

In one aspect, each of processor 1112 and processor 1122 may be implemented in the form of one or more single-core processors, one or more multi-core processors, one or more RISC processors or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including those pertaining to new MCS levels for next-generation WLANs in accordance with various implementations of the present disclosure.

In some implementations, apparatus 1110 may also include a transceiver 1116 coupled to processor 1112. Transceiver 1116 may include a transmitter capable of wirelessly transmitting and a receiver capable of wirelessly receiving data. In some implementations, apparatus 1120 may also include a transceiver 1126 coupled to processor 1122. Transceiver 1126 may include a transmitter capable of wirelessly transmitting and a receiver capable of wirelessly receiving data. It is noteworthy that, although transceiver 1116 and transceiver 1126 are illustrated as being external to and separate from processor 1112 and processor 1122, respectively, in some implementations, transceiver 1116 may be an integral part of processor 1112 as a system on chip (SoC), and transceiver 1126 may be an integral part of processor 1122 as a SoC.

In some implementations, apparatus 1110 may further include a memory 1114 coupled to processor 1112 and capable of being accessed by processor 1112 and storing data therein. In some implementations, apparatus 1120 may further include a memory 1124 coupled to processor 1122 and capable of being accessed by processor 1122 and storing data therein. Each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

Each of apparatus 1110 and apparatus 1120 may be a communication entity capable of communicating with each other using various proposed schemes in accordance with the present disclosure. For illustrative purposes and without limitation, a description of capabilities of apparatus 1110, as STA 110, and apparatus 1120, as STA 120, is provided below. It is noteworthy that, although a detailed description of capabilities, functionalities and/or technical features of apparatus 1120 is provided below, the same may be applied to apparatus 1110 although a detailed description thereof is not provided solely in the interest of brevity. It is also noteworthy that, although the example implementations described below are provided in the context of WLAN, the same may be implemented in other types of networks.

Under various proposed schemes pertaining to new MCS levels for next-generation WLANs in accordance with the present disclosure, with apparatus 1110 implemented in or as STA 110 and apparatus 1120 implemented in or as STA 120 in network environment 100, processor 1112 of apparatus 1110 may generate a signal using an MCS level from a plurality of MCS levels not defined in an IEEE 802.11be specification. Moreover, processor 1112 may perform, via transceiver 1116, a wireless communication using the signal. Each of a sensitivity SNR gap and a spectral efficiency gap between two adjacent MCS levels from a combination of the plurality of MCS levels and a plurality of existing MCS levels defined in the IEEE 802.11be specification may be less than that between two adjacent MCS levels from the plurality of existing MCS levels.

In some implementations, the MCS level may include an MCS-a using a BPSK modulation with a number of coded bits per subcarrier per spatial stream (N_{bpscs})=1, a coding rate (R)=½, a number of times of tone repetition=6 and an effective coding rate (eR)= 1/12.

In some implementations, the MCS level may include an MCS-c using a BPSK modulation with N_{bpscs}=1, R=½, a number of times of tone repetition=3 and eR=⅙.

In some implementations, the MCS level may include an MCS-d using a BPSK modulation with N_{bpscs}=1, R=⅔, a number of times of tone repetition=2 and eR=⅓.

In some implementations, the MCS level may include an MCS-e using a QPSK modulation with N_{bpscs}=2, R=½, a number of times of tone repetition=2 and eR=¼.

In some implementations, the MCS level may include an MCS-g using a BPSK modulation with N_{bpscs}=1, R=¾, a number of times of tone repetition=1 and eR=¾.

In some implementations, the MCS level may include an MCS-i using a QPSK modulation with N_{bpscs}=2, R=⅚, a number of times of tone repetition=1 and eR=⅚.

In some implementations, the MCS level may include an MCS-j using a QPSK modulation with N_{bpscs}=2, R=⅞, a number of times of tone repetition=1 and eR=⅞.

In some implementations, the MCS level may include an MCS-1 using a 16-quadrature amplitude modulation (16QAM) with N_{bpscs}=4, R=⅚, a number of times of tone repetition=1 and eR=⅚.

In some implementations, the MCS level may include an MCS-m using a 16-quadrature amplitude modulation (16QAM) with N_{bpscs}=4, R=⅞, a number of times of tone repetition=1 and eR=⅞.

In some implementations, the MCS level may include an MCS-n using a 256-quadrature amplitude modulation (256QAM) with N_{bpscs}=8, R=2/3, a number of times of tone repetition=1 and eR=⅔.

In some implementations, the MCS level may include an MCS-p using 256QAM with N_{bpscs}=8, R=⅞, a number of times of tone repetition=1 and eR=⅞.

In some implementations, the MCS level may include an MCS-r using a 1024-quadrature amplitude modulation (1024QAM) with N_{bpscs}=10, R=⅞, a number of times of tone repetition=1 and eR=⅞.

In some implementations, the MCS level may include an MCS-t using a 4096-quadrature amplitude modulation (4096QAM) with N_{bpscs}=12, R=⅞, a number of times of tone repetition=1 and an eR=⅞.

### Illustrative Processes

FIG. 12 illustrates an example process 1200 in accordance with an implementation of the present disclosure. Process 1200 may represent an aspect of implementing various proposed designs, concepts, schemes, systems and methods described above. More specifically, process 1200 may represent an aspect of the proposed concepts and schemes pertaining to new MCS levels for next-generation WLANs in accordance with the present disclosure. Process 1200 may include one or more operations, actions, or functions as illustrated by one or more of blocks 1210 and 1220 as well as subblocks 1222 and 1224. Although illustrated as discrete blocks, various blocks of process 1200 may be divided into additional blocks, combined into fewer blocks, or eliminated, depending on the desired implementation. Moreover, the blocks/sub-blocks of process 1200 may be executed in the order shown in FIG. 12 or, alternatively in a different order. Furthermore, one or more of the blocks/sub-blocks of process 1200 may be executed repeatedly or iteratively. Process 1200 may be implemented by or in apparatus 1110 and apparatus 1120 as well as any variations thereof. Solely for illustrative purposes and without limiting the scope, process 1200 is described below in the context of apparatus 1110 implemented in or as STA 110 functioning as a non-AP STA and apparatus 1120 implemented in or as STA 120 functioning as an AP STA of a wireless network such as a WLAN in network environment 120 in accordance with one or more of IEEE 802.11 standards. Process 1200 may begin at block 1210.

At 1210, process 1200 may involve processor 1112 of apparatus 1110 generating a signal using an MCS level from a plurality of MCS levels not defined in an IEEE 802.11be specification. Process 1200 may proceed from 1210 to 1220.

At 1220, process 1200 may involve processor 1112 performing, via transceiver 1116, a wireless communication using the signal. Each of a sensitivity SNR gap and a spectral efficiency gap between two adjacent MCS levels from a combination of the plurality of MCS levels and a plurality of existing MCS levels defined in the IEEE 802.11be specification may be less than that between two adjacent MCS levels from the plurality of existing MCS levels.

In some implementations, the MCS level may include an MCS-a using a BPSK modulation with N_{bpscs}=1, R=½, a number of times of tone repetition=6 and eR= 1/12.

In some implementations, the MCS level may include an MCS-c using a BPSK modulation with N_{bpscs}=1, R=½, a number of times of tone repetition=3 and eR=⅙.

In some implementations, the MCS level may include an MCS-d using a BPSK modulation with N_{bpscs}=1, R=⅔, a number of times of tone repetition=2 and eR=⅓.

In some implementations, the MCS level may include an MCS-e using a QPSK modulation with N_{bpscs}=2, R=½, a number of times of tone repetition=2 and eR=¼.

In some implementations, the MCS level may include an MCS-g using a BPSK modulation with N_{bpscs}=1, R=¾, a number of times of tone repetition=1 and eR=¾.

In some implementations, the MCS level may include an MCS-i using a QPSK modulation with N_{bpscs}=2, R=⅚, a number of times of tone repetition=1 and eR=⅚.

In some implementations, the MCS level may include an MCS-j using a QPSK modulation with N_{bpscs}=2, R=⅞, a number of times of tone repetition=1 and eR=⅞.

In some implementations, the MCS level may include an MCS-1 using a 16-quadrature amplitude modulation (16QAM) with N_{bpscs}=4, R=⅚, a number of times of tone repetition=1 and eR=⅚.

In some implementations, the MCS level may include an MCS-m using a 16QAM with N_{bpscs}=4, R=⅞, a number of times of tone repetition=1 and eR=⅞.

In some implementations, the MCS level may include an MCS-n using a 256QAM with N_{bpscs}=8, R=2/3, a number of times of tone repetition=1 and eR=⅔.

In some implementations, the MCS level may include an MCS-p using 256QAM with N_{bpscs}=8, R=⅞, a number of times of tone repetition=1 and eR=⅞.

In some implementations, the MCS level may include an MCS-r using a 1024QAM with N_{bpscs}=10, R=⅞, a number of times of tone repetition=1 and eR=⅞.

In some implementations, the MCS level may include an MCS-t using a 4096QAM with N_{bpscs}=12, R=⅞, a number of times of tone repetition=1 and an eR=⅞.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
generating, by a processor of an apparatus, a signal using a modulation and coding scheme (MCS) level from a plurality of MCS levels not defined in an Institute of Electrical and Electronics Engineers (IEEE) 802.11be specification; and
performing, by the processor, a wireless communication using the signal,
wherein each of a sensitivity signal-to-noise ratio (SNR) gap and a spectral efficiency gap between two adjacent MCS levels from a combination of the plurality of MCS levels and a plurality of existing MCS levels defined in the IEEE 802.11be specification is less than that between two adjacent MCS levels from the plurality of existing MCS levels.

2. The method of claim 1, wherein the MCS level comprises an MCS-a using a binary phase-shift keying (BPSK) modulation with a number of coded bits per subcarrier per spatial stream (N_{bpscs})=1, a coding rate (R)=½, a number of times of tone repetition=6 and an effective coding rate (eR)= 1/12.

3. The method of claim 1, wherein the MCS level comprises an MCS-c using a binary phase-shift keying (BPSK) modulation with a number of coded bits per subcarrier per spatial stream (N_{bpscs})=1, a coding rate (R)=½, a number of times of tone repetition=3 and an effective coding rate (eR)=⅙.

4. The method of claim 1, wherein the MCS level comprises an MCS-d or an MCS-e, wherein MCS-d uses a binary phase-shift keying (BPSK) modulation with a number of coded bits per subcarrier per spatial stream (N_{bpscs})=1, a coding rate (R)=⅔, a number of times of tone repetition=2 and an effective coding rate (eR)=⅓, and wherein MCS-e uses a quadrature phase-shift keying (QPSK) modulation with a number of coded bits per subcarrier per spatial stream (N_{bpscs})=2, a coding rate (R)=½, a number of times of tone repetition=2 and an effective coding rate (eR)=¼.

5. The method of claim 1, wherein the MCS level comprises an MCS-g using a binary phase-shift keying (BPSK) modulation with a number of coded bits per subcarrier per spatial stream (N_{bpscs})=1, a coding rate (R)=¾, a number of times of tone repetition=1 and an effective coding rate (eR)=¾.

6. The method of claim 1, wherein the MCS level comprises an MCS-j or an MCS-i, wherein MCS-j uses a quadrature phase-shift keying (QPSK) modulation with a number of coded bits per subcarrier per spatial stream (N_{bpscs})=2, a coding rate (R)=⅞, a number of times of tone repetition=1 and an effective coding rate (eR)=⅞, and wherein MCS-i uses a quadrature phase-shift keying (QPSK) modulation with a number of coded bits per subcarrier per spatial stream (N_{bpscs})=2, a coding rate (R)=⅚, a number of times of tone repetition=1 and an effective coding rate (eR)=⅚.

7. The method of claim 1, wherein the MCS level comprises an MCS-m or an MCS-1, wherein MCS-m uses a 16-quadrature amplitude modulation (16QAM) with a number of coded bits per subcarrier per spatial stream (N_{bpscs})=4, a coding rate (R)=⅞, a number of times of tone repetition=1 and an effective coding rate (eR)=⅞, and wherein MCS-1 uses a 16-quadrature amplitude modulation (16QAM) with a number of coded bits per subcarrier per spatial stream (N_{bpscs})=4, a coding rate (R)=⅚, a number of times of tone repetition=1 and an effective coding rate (eR)=⅚.

8. The method of claim 1, wherein the MCS level comprises an MCS-n using a 256-quadrature amplitude modulation (256QAM) with a number of coded bits per subcarrier per spatial stream (N_{bpscs})=8, a coding rate (R)=⅔, a number of times of tone repetition=1 and an effective coding rate (eR)=⅔.

9. The method of claim 1, wherein the MCS level comprises an MCS-p using a 256-quadrature amplitude modulation (256QAM) with a number of coded bits per subcarrier per spatial stream (N_{bpscs})=8, a coding rate (R)=⅞, a number of times of tone repetition=1 and an effective coding rate (eR)=⅞.

10. The method of claim 1, wherein the MCS level comprises an MCS-r using a 1024-quadrature amplitude modulation (1024QAM) with a number of coded bits per subcarrier per spatial stream (N_{bpscs})=10, a coding rate (R)=⅞, a number of times of tone repetition=1 and an effective coding rate (eR)=⅞.

11. The method of claim 1, wherein the MCS level comprises an MCS-t using a 4096-quadrature amplitude modulation (4096QAM) with a number of coded bits per subcarrier per spatial stream (N_{bpscs})=12, a coding rate (R)=⅞, a number of times of tone repetition=1 and an effective coding rate (eR)=⅞.

12. An apparatus, comprising:
a transceiver configured to communicate wirelessly; and
a processor coupled to the transceiver and configured to perform operations comprising:
generating a signal using a modulation and coding scheme (MCS) level from a plurality of MCS levels not defined in an Institute of Electrical and Electronics Engineers (IEEE) 802.11be specification; and
performing, via the transceiver, a wireless communication using the signal,
wherein each of a sensitivity signal-to-noise ratio (SNR) gap and a spectral efficiency gap between two adjacent MCS levels from a combination of the plurality of MCS levels and a plurality of existing MCS levels defined in the IEEE 802.11be specification is less than that between two adjacent MCS levels from the plurality of existing MCS levels.

13. The apparatus of claim 12, wherein the MCS level comprises an MCS-a or an MSC-c using a binary phase-shift keying (BPSK) modulation with a number of coded bits per subcarrier per spatial stream (N_{bpscs})=1, a coding rate (R)=½, a number of times of tone repetition=6 or a number of times of tone repetition=3.

14. (canceled)

15. The apparatus of claim 12, wherein the MCS level comprises an MCS-d or an MCS-e, wherein MCS-d uses a binary phase-shift keying (BPSK) modulation with a number of coded bits per subcarrier per spatial stream (N_{bpscs})=1, a coding rate (R)=⅔, a number of times of tone repetition=2 and an effective coding rate (eR)=⅓, and wherein MCS-e uses a quadrature phase-shift keying (QPSK) modulation with a number of coded bits per subcarrier per spatial stream (N_{bpscs})=2, a coding rate (R)=½, a number of times of tone repetition=2 and an effective coding rate (eR)=¼.

16. The apparatus of claim 12, wherein the MCS level comprises an MCS-g using a binary phase-shift keying (BPSK) modulation with a number of coded bits per subcarrier per spatial stream (N_{bpscs})=1, a coding rate (R)=¾, a number of times of tone repetition=1 and an effective coding rate (eR)=¾.

17. The apparatus of claim 12, wherein the MCS level comprises an MCS-j or an MCS-i, wherein MCS-j uses a quadrature phase-shift keying (QPSK) modulation with a number of coded bits per subcarrier per spatial stream (N_{bpscs})=2, a coding rate (R)=⅞, a number of times of tone repetition=1 and an effective coding rate (eR)=⅞, and wherein MCS-i uses a quadrature phase-shift keying (QPSK) modulation with a number of coded bits per subcarrier per spatial stream (N_{bpscs})=2, a coding rate (R)=⅚, a number of times of tone repetition=1 and an effective coding rate (eR)=⅚.

18. The apparatus of claim 12, wherein the MCS level comprises an MCS-m or an MCS-1, wherein MCS-1 uses a 16-quadrature amplitude modulation (16QAM) with a number of coded bits per subcarrier per spatial stream (N_{bpscs})=4, a coding rate (R)=⅞, a number of times of tone repetition=1 and an effective coding rate (eR)=⅞, and wherein MCS-1 uses a 16-quadrature amplitude modulation (16QAM) with a number of coded bits per subcarrier per spatial stream (N_{bpscs})=4, a coding rate (R)=⅚, a number of times of tone repetition=1 and an effective coding rate (eR)=⅚.

19. The apparatus of claim 12, wherein the MCS level comprises an MCS-n or an MSC-p using a 256-quadrature amplitude modulation (256QAM) with a number of coded bits per subcarrier per spatial stream (N_{bpscs})=8, a coding rate (R)=⅔ or a coding rate (R)=⅞, a number of times of tone repetition=1.

20. (canceled)

21. The apparatus of claim 12, wherein the MCS level comprises an MCS-r using a 1024-quadrature amplitude modulation (1024QAM) with a number of coded bits per subcarrier per spatial stream (N_{bpscs})=10, a coding rate (R)=⅞, a number of times of tone repetition=1 and an effective coding rate (eR)=⅞.

22. The apparatus of claim 12, wherein the MCS level comprises an MCS-t using a 4096-quadrature amplitude modulation (4096QAM) with a number of coded bits per subcarrier per spatial stream (N_{bpscs})=12, a coding rate (R)=⅞, a number of times of tone repetition=1 and an effective coding rate (eR)=⅞.
